(19) United States
(12) Patent Application Publication
(10) Pub. No.: US 2010/0028645 A1
(43) Pub. Date: Feb. 4, 2010

(54) Adaptive supports for green state articles and methods of processing thereof

(76) Inventors: Michael Maguire, Napa, CA (US); Michael D. Baldwin, American Canyon, CA (US); Max Eric Schlienger, Napa, CA (US)

Correspondence Address: KRIEG DEVAULT LLP, ONE INDIANA SQUARE, SUITE 2800, INDIANAPOLIS, IN, 46204-2079, US

(21) Appl. No.: 12/221,563

(22) Filed: Aug. 4, 2008

(51) Int. Cl. B32B 18/00

(52) U.S. Cl. 428/221; 264/401; 428/688

(57) ABSTRACT

Supports for green ceramic stereolithography parts are disclosed which limit or minimize deformation during burnout and sintering. The supports have a time/temperature thermal response tuned to the part being sintered and control geometrically-induced distortion or gravimetric sag.

### TECHNICAL FIELD

The technical field relates generally to green bodies including a particulate material and a binder matrix.

### BACKGROUND

Engineers and scientists appreciate that green state bodies are subjected to forces and/or relative movements that may contribute to deformations during thermal processing such as burnout or sintering. Some of these forces and/or relative movements may include gravimetric sag and geometric-induced distortions. In some cases, these deformations may result in loss of dimensional accuracy and/or may cause significant flaws in a final part. Supporting a green state body during burnout and/or sintering to reduce and/or mitigate deformations in the final part remains an area of interest. Accordingly, the present application provides further contributions in this area of technology.

### SUMMARY

One embodiment of the present invention contemplates a green state ceramic article and a support or supports having similar shrinkages when thermally processed. Other embodiments include apparatuses, systems, devices, hardware, methods, and combinations for supporting green articles. Further embodiments, forms, features, aspects, benefits, and advantages of the present application shall become apparent from the description and figures provided herewith.

### BRIEF DESCRIPTION OF THE FIGURES

FIG. 1 is an illustrative embodiment of a green state article and support of the present application.

FIG. 2 is an illustrative embodiment of another green state article and support of the present application.

FIG. 3 is an illustrative embodiment of another green state article and support of the present application.

FIG. 4 is an illustrative embodiment of another green state article and support of the present application.

FIG. 5 is an illustrative embodiment of another green state article and support of the present application.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

One aspect of the present application contemplates a supporting structure that shrinks at a similar rate as the primary object of interest such as a part during a thermal processing operation. Due to the linear shrinkage, the supporting structure is intended to prevent thermally induced morphology changes by moving with the primary object of interest such as the part during thermal processing. The supporting structure are contemplated to move with the primary object of interest such as the part as they experience linear shrinkage associated with thermal processing while minimizing the gravimetric sag associated with relatively high temperature softening.

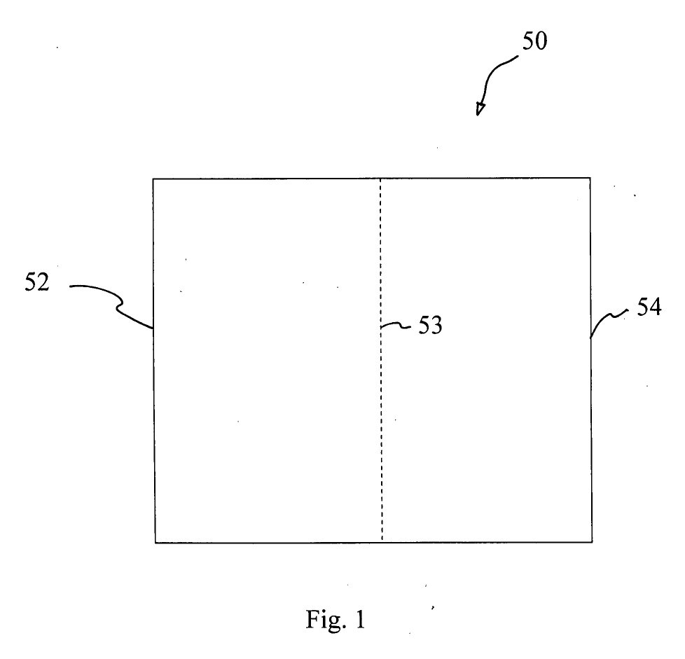

With reference to FIG. 1, a green state article 50 is shown having an integral part 52 and support 54, wherein the boundary between the two is generally denoted by a dashed line 53. The present application further contemplates that the part and support need not be integrally formed. The present application is applicable to green state articles formed from a fugitive binder and particulate. In one form the fugitive binder is organic. A preferred form of the present application is a green state ceramic body, however green state bodies having other types of particulate material such as metals, glasses, carbon fiber or nanotubes, inorganic fibers, or particulate such as but not limited to asbestos and others are contemplated herein. The present application may also be applicable to carbon/carbon composites. More generally, the present application is applicable to any object that undergoes shrinkage as it is transformed from a green state to a final configuration. The present application will utilize a green ceramic article for illustrative and descriptive purposes; however the present application is also applicable to green state articles formed of other particulate materials which are fully contemplated herein.

The illustrative embodiment in FIG. 1 depicts a single boundary denoted by 53, but in some embodiments the green ceramic article 50 may have multiple boundaries, which might be represented by multiple dashed lines 53, such that multiple supports 54, and/or multiple parts 52, may be present. For example, a single part 52 may be supported by multiple supports 54, wherein multiple boundaries between the two would be present. Another non-limiting example of the support of a part 52 is the case where the part is fully or partially encased with a mesh support 54. In one form the mesh is an octet mesh, which is a combination of tetrahedrons and octahedrons. In another example, multiple parts 52 may be supported by a single support 54. The interface of the support 54 and the part 52, or the interface between one or more supports 54 and one or more parts 52, is non-stationary, or substantially non-stationary, within a reference frame fixed in a furnace. In those embodiments having multiple supports, the relative spacing between supports may change during thermal processing events such as burnout or sintering.

In some embodiments, dashed line 53 may be an arbitrary or otherwise artificial boundary. For example, the demarcation between part 52 and support 54 may be difficult to precisely identify as the boundaries may be blurred between what portion of the green ceramic article 50 forms the part 52 and what portion forms the support 54.

Regardless of where or how the boundaries are defined in the green ceramic article 50, the spatial and temporal thermal response characteristics of the part 52 and support 54 are similar such that forces that may cause deformation during burnout or sintering are mitigated or eliminated. In another form the spatial and temporal thermal response characteristics of the part 52 and the support 54 are substantially identical and in yet another form the spatial and temporal thermal response characteristics of the part 52 and support 54 are identical such that forces that cause deformation during burnout or sintering are mitigated or eliminated. Supports 54 that have the same or similar spatial and temporal thermal response characteristic as the part 52 will shrink at the same or at a similar rate as the part during burnout and/or sintering, thus mitigating and/or reducing some forces that cause deformation in a sintered article.

The green state article in the illustrative embodiment is formed by stereolithography techniques, but other techniques of forming and/or building three-dimensional objects are also contemplated herein. The present application contemplates both layer built structures and non-layer built structures. The definition of stereolithography techniques as utilized herein contemplates the use of one or more of the following, but not limited to, laser, flash cure, rastered radiation, masked radiation, intensity modulated light or other techniques for achieving a desired exposure. The application contemplates that the layer may be cured at once as in a flash cure or be cured in a rastered laser sequential cure. In one form of the present application the flash cure utilizes a direct light process (DLP). For example, the green ceramic article 50 may also be formed using other rapid prototyping techniques such as gel casting, selective laser sintering and three-dimensional printing.

The stereolithography techniques useful for constructing the green ceramic article 50 can be described in some applications as exposing a select portion of a photocurable ceramic slurry to light to form a plurality of photocured layers of ceramic particles held together by a polymer binder. The ceramic slurry is typically composed of ceramic particles suspended, interspersed, mixed, or otherwise held in contact with a photopolymerisable monomer. In some applications, the photopolymerisable monomer may be replaced with other suitable substances such a photopolymerisable polymer, to set forth just one nonlimiting example. In some dispersions the ceramic particles may or may not be evenly dispersed at any given time. In some compositions the ceramic dispersion might include additives such as dispersants and thickening agents, among others. The ceramic particles suspended in the ceramic dispersion may be any suitable composition, including alumina and zirconia, to set forth just two nonlimiting examples. For additional information regarding various aspects of ceramic stereolithography, please see for example U.S. Pat. No. 7,343,960 which is incorporated herein by reference

In one non-limiting form the photopolymerisable monomer is irradiated with a UV laser to form a solid, photocured polymer layer. However, as discussed above the present application fully contemplates the use of other forms of exposure than a laser. After a first layer of photocured polymer is created, an amount of photocurable ceramic dispersion is then placed above the photocured polymer layer, and the UV laser is then scanned across the surface to create another layer of photocured polymer. Many layers are then fashioned in this way to build a three-dimensional shape. The amount of photocurable ceramic dispersion that is placed above the photocured polymer layer can be accomplished by lowering the photocured polymer layer into a vat of photocurable ceramic dispersion. Other techniques may also be used to place an amount of photocurable ceramic dispersion above a photocured polymer layer.

After the three-dimensional shape has been built, the green ceramic article 50 is “fired”, or processed, within a furnace or other suitable structure by heating it to a temperature suitable to burnout the photocured polymer thus leaving a body that is substantially ceramic but that may include some residuals. The remaining ceramic body is then typically sintered at a second, higher temperature to form a final, densified body. In some applications the final, densified body may or may not contain a residual amount of porosity, depending on the desired final level of densification.

The part 52 forms a portion of the ceramic green article 50 and can be used after burnout and sintering as a shell or core for investment casting operations. For example, part 52 can be used as a mold useful for casting an airfoil having internal coolant passages, such as for a turbine blade used in an aircraft gas turbine engine. As used herein, the term aircraft includes, but is not limited to, helicopters, airplanes, unmanned space vehicles, fixed wing vehicles, variable wing vehicles, rotary wing vehicles, hover crafts, vehicles, and others. Further, the present inventions are contemplated for utilization in other applications that may not be coupled with an aircraft such as, for example, industrial applications, power generation, pumping sets, naval propulsion and other applications known to one of ordinary skill in the art.

The part 52 can be designed for use with another, separately made part or support, in a casting or other type of manufacturing operation. If used in a casting operation, the part 52 can be removed from a cast material via any suitable process, including destructive processes such as via mechanical means, such as water blasting, or chemical means, such as leaching, to set forth just two nonlimiting examples. Other uses of part 52 are also envisioned herein.

In one form the support 54 forms a portion of the ceramic green article 50 and is used to provide support for part 52 during burnout and/or sintering against forces that cause deformation such as gravity, to set forth just one nonlimiting example. The support 54 can also be used in some embodiments to control geometrically-induced distortion, as might be the case with an airfoil that tends to lose its cambered shape during sintering. The effects of other deformation-inducing forces and/or phenomena can also be reduced and/or eliminated by the support 54. The support 54 can be of any shape and may be found in multiple portions of the green ceramic article 50. To set forth just a few nonlimiting examples, the support 54 may take the form of shelves, posts, and stilts and in some applications may be referred to as kiln furniture. In some applications the support 54 may be removed after burnout or after sintering. For example, after sintering the support 54 may be removed by mechanical or other means to reduce the size of the ceramic article and allow independent use of the part 52.

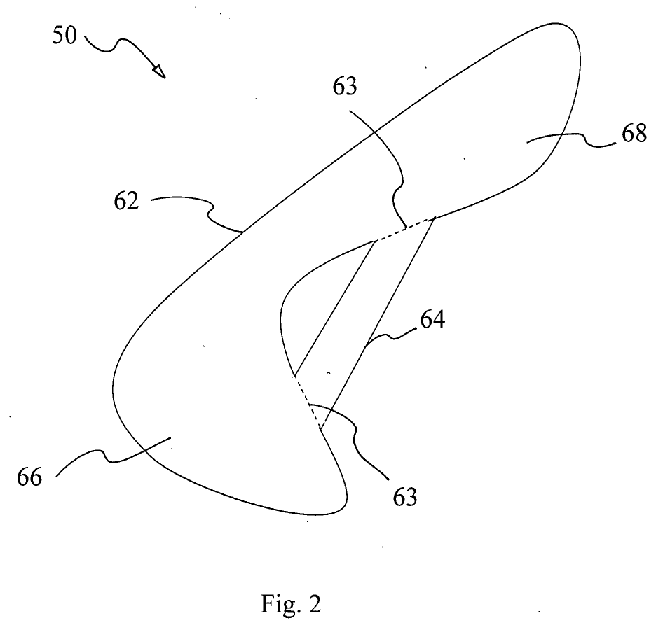

With reference to FIG. 2, there is illustrated another embodiment of the green ceramic article 50 including a part 62. Part 62 is formed in a crescent shape that is supported by support 64 which extends between a first portion 66 and a second portion 68 of part 62. The formation as a crescent is exemplary and the present application is not limited to any specific shape unless specifically provided to the contrary. Dashed line 63 denotes the boundary between the part 62 and support 64. The support 62 may be used to prevent or minimize deformations of part 62 during burnout and/or sintering. In some applications the support 64 may be removed from the part 62 after either burnout or sintering.

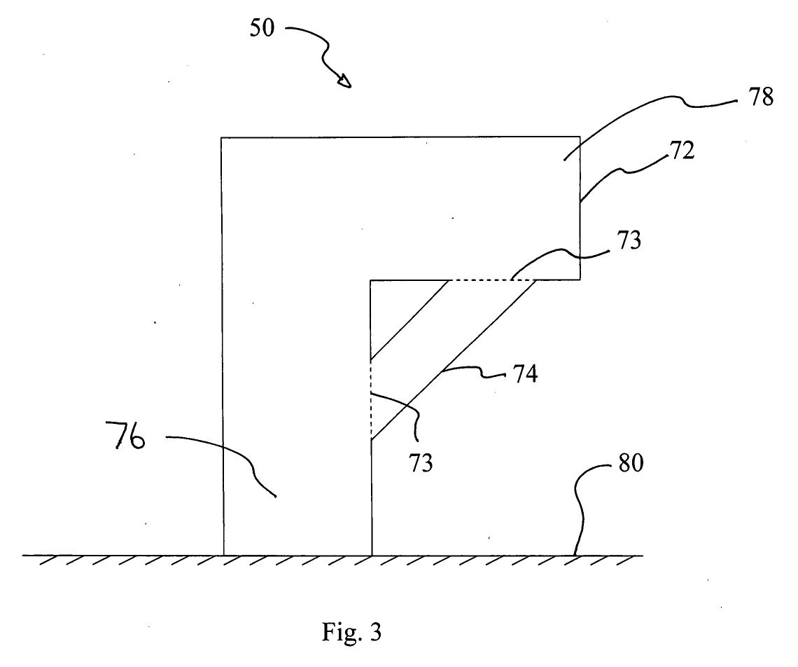

FIG. 3 depicts yet another embodiment of the green ceramic article 50 including a part 72. Part 72 includes a base 76 and an overhang 78. Dashed line 73 denotes the boundary between the part 72 and support 74. The overhang 78 is supported by a support 74 such that the overhang does not sag under the influence of gravity during processing. The floor 80 may represent a furnace floor or other structure intended to be used within a furnace for burnout and/or sintering.

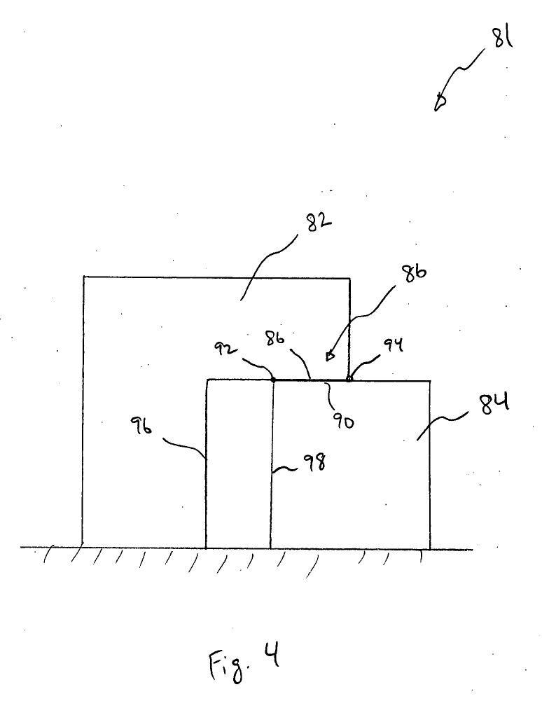

With reference to FIG. 4, a construction 81 of two separate green state articles is shown wherein one of the green state articles is a part 82 and the other a support 84. The support 84 in the embodiment depicted in FIG. 4 may be used to prevent, reduce, or mitigate gravimetric sag in the part 82 during thermal processing. In some embodiments more than one support 84 may be provided in the construction to provide support for the part 82. In other embodiments, one support 84 may be used with more than one part 82. The interface 86 between the support 84 and the part 82 is non-stationary relative to a furnace or other device within which the support 84 and part 82 are thermally processed.

The interface 86 includes a part surface 88 and a support surface 90 that are engaged in physical contact with each other. The part surface 88 and the support surface 90 are shown as two flat surfaces in the illustrative embodiment, but may take the form of different shapes in other embodiments. For example, the part surface 88 and the support surface 90 may be sawtooth shaped, sinusoidal, or any other variety of shapes. The part surface 88 and the support surface 90 are physically engaged over substantially all of the distance between points 92 and 94, but in some embodiments the surfaces 88 and 90 may not be physically engaged over at least a portion or portions of the distance between points 92 and 94. Although only one surface of each of the part 82 and support 84 are depicted in physical contact, some embodiments may include a part and support having contact over more than just one surface. For example, the part side surface 96 and the support side surface 98 may be in physical contact in some embodiments.

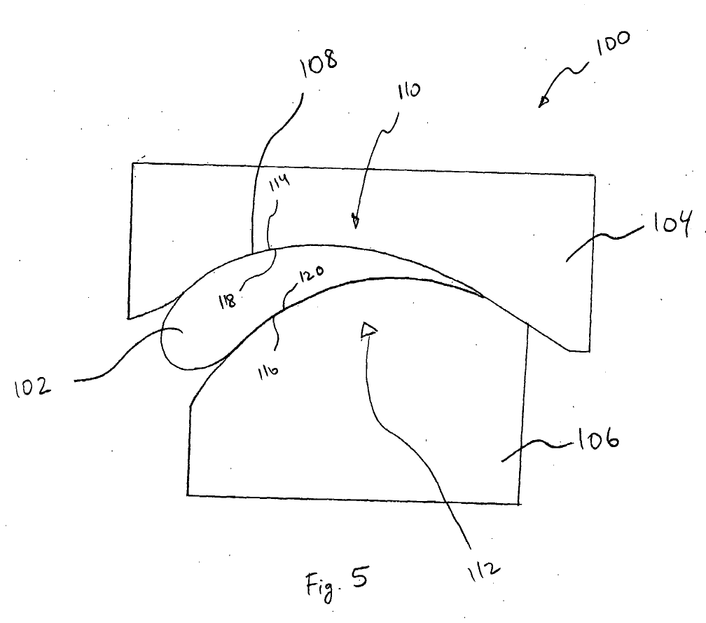

With reference to FIG. 5, a construction 100 of three separate green state articles are shown, one is a part 102 and the other two are supports 104 and 106. The supports 104 and 106 in the embodiment depicted in FIG. 5 can be used to prevent, reduce, or mitigate geometric induced distortions. In particular, the supports 104 and 106 may be used to prevent the airfoil shape 108 of the part 102 from de-cambering during a thermal processing event such as sintering.

Interfaces 110 and 112 between the part 102 and the supports 104 and 106 are non-stationary relative to a furnace or other device within which the supports 104 and 106 as well as the part 102 are thermally processed The interfaces 110 and 112 include, respectively, support surfaces 114 and 116 that are engaged in physical contact with the part surfaces 118 and 120. In some embodiments, portions of the interfaces 110 and 112 may include surfaces that are not in physical contact with each other.

The present application further contemplates that in some forms the part(s) and support(s) may have anisotropic shrinkage characteristics. Currently pending and commonly owned U.S. patent application Ser. No. 11/788,286 titled Method and Apparatus Associated With Anisotropic Shink In Sintered Ceramic Items is incorporated herein by reference. Application Ser. No. 11/788,786 sets forth techniques to quantify and account for anisotropic shrinkage in sinterable components. In one form the present application matches the overall shrinkage of the part and it's associated shrinkage rate with the overall shrinkage and associated shrinkage rate of the support. In an embodiment where the part and support are separate components the part and the support are situated so as to be constructed with a common build orientation. In another embodiment where the part and the support are separate components the part and support are situated so as to be constructed with a common build orientation at their interface.

In one form a three dimensional coordinate system (example XYZ) of the item being fabricated and the stereolithography apparatus' coordinate system are coextensive. Within a layer formed in a stereolithography apparatus that utilized a wiper blade moved in the direction of axis Y to level the photo-polymerizable ceramic filled resin prior to receiving a dose of energy there will be an affect on the resin. The wiper blade interacts with the photo-polymerizable ceramic filled material and affects the homogeneity in at least two dimensions. Shrinkage in the item associated with a subsequent sintering act is anisotropic in the three directions. Anisotropic shrinkage can be considered to occur when isotropic shrinkage is not sufficient to keep the sintered item within a predetermined geometric tolerance. In the discussion of the anisotropic shrinkage relative to the X, Y and Z axis the Z axis represents the build direction and the Y axis represents the direction of the movement of the wiper blade. The inventors in the commonly owned application Ser. No. 11/788,286 have determined that shrinkage in the Z direction (build direction) is greater than in the X and Y directions. Factors to consider when evaluating the shrinkage are the solid loading in the photo-polymerizable resin, the resin formulation, the build style and orientation and how the item is sintered.

The present application contemplates utilization of a shrinkage factors associated with each of the X, Y and Z directions/dimensions. The shrinkage factors are then applied to a model, file or other representation of the part and support to expand the dimensions in the respective directions of the coordinate system. The shrinkage factors are utilized to adjust the underlying dimensions in the X, Y and Z direction to account for the anisotropic shrinkage of the item.

In one form of the present application the shrinkage factors determination utilizes a shrinkage measurement test model; which is created as a solid body model and then generated as an STL file. In one form the item is oriented such that the back corner represents the origin of a Cartesian coordinate system X, Y, Z. The vertical direction of the STL being aligned with the Z axis and the two sides being aligned with the X and Y axis respectively. The item is then built in a stereolithography apparatus with the Cartesian coordinate system of the item aligned with the coordinate system of the stereolithography apparatus. The shrinkage measurement test model in the green state is then subjected to a comprehensive inspection to quantify dimensions of the item. The measurements taken during inspection can be obtained with known equipment such as, but not limited to calipers and/or coordinate measuring machines. In one form the shrinkage measurement test model has been designed so that all of the inspection dimensions line up along the X, Y and/or Z axis. The item is then subjected to a firing act to burn off the photo-polymer and sinter the ceramic material. The comprehensive inspection is repeated to quantify the dimensions of the item after being sintered.

The measured values from the comprehensive inspection after firing are than compared with the inspection values from the green state item. In one form the comparison is done by plotting the measured values of the fired item against the measured values from the green state item. A least squares analysis is performed to obtain a linear equation. The resulting slope of the equations is the shrinkage factors for each of the X, Y and Z direction/dimensions. The shrinkage for each of the X, Y and Z directions/dimensions are then applied to the file, data and/or model to expand the dimensions in the respective directions of the coordinate system. As set forth above further details in accounting for anisotropic shrinkage are set forth in commonly owned application Ser. No. 11/788,786

One aspect of the present application includes a green state article formed by rapid prototyping techniques. The green state article includes an integral part portion and a support portion, where the part portion is formed in the shape of a desired object, such as a mold, and the support portion provides support for the part portion during processing acts such as burnout and/or sintering.

Another aspect of the present application includes a green state part formed by rapid prototyping techniques and a green state support. The green state part is formed in the shape of a desired object, such as a mold, and the green state support portion provides support for the part portion during processing acts such as burnout and/or sintering.

Another aspect of the present application contemplates an apparatus comprising: a green article having a part defining portion and a firing support portion each of the portions formed of a plurality of layers coupled together by a sacrificial polymer binder, and each of the plurality of layers includes a particulate material held together by the sacrificial polymer binder; and the portions having a similar thermal shrinkage rate.

Yet another aspect of the present application contemplates a method comprising: forming a layered green ceramic article having a firing support portion and a part portion by stereolithography; tuning a thermal response property of the firing support portion and the part portion; and thermally removing a sacrificial binder from the green ceramic article.

Yet another aspect of the present application contemplates an apparatus comprising: a green body formed of a plurality of layers coupled together by a sacrificial polymer binder, each of the plurality of layers includes a particulate material held together by the sacrificial polymer binder; and means for reducing deformation of the green body during burnout and sintering.

Yet another aspect of the present application contemplates an apparatus comprising: a green article construction having a part and a firing support in mutual engagement, the part and the support having a similar shrinkage property when thermally processed; and an interface defined by the engagement between the part and the firing support, the interface is operable to be non-stationary relative to a furnace when the green article construction is thermally processed.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus comprising:
a green article having a part defining portion and a firing support portion each of the portions formed of a plurality of layers coupled together by a sacrificial polymer binder, and each of the plurality of layers includes a particulate material held together by the sacrificial polymer binder; and
the portions having a similar thermal shrinkage rate.

2. The apparatus of claim 1, wherein the green article is a green ceramic article.

3. The apparatus of claim 1, wherein the part defining portion and the firing support portion are integrally formed.

4. The apparatus of claim 3, wherein the firing support portion is a octet mesh encasing at least a portion of the part defining portion.

5. The apparatus of claim 1, wherein the green article has a structure consistent with formation by stereolithography.

6. The apparatus of claim 1, wherein the green article has a structure consistent with formation by a flash cure from digital light processing.

7. The apparatus of claim 1, wherein the part defining portion and the firing support portion shrink at substantially the same rate.

8. The apparatus of claim 1, wherein the part defining portion and the firing support portion shrink at the same rate.

9. The apparatus of claim 1, wherein the firing support portion supports the part defining portion against gravity forces.

10. The apparatus of claim 1, wherein the firing support portion isolates the part defining portion from a furnace floor.

11. The apparatus of claim 1, wherein the part defining portion defines at least a part of an investment casting mold.

12. The apparatus of claim 11, wherein the part of an investment casting mold comprises a casting core.

13. The apparatus of claim 1, wherein the particulate material is a ceramic material;
wherein the green article is formed by stereolithography;
wherein the part defining portion and the firing support portion are integrally connected; and
wherein the firing support portion supports the part defining portion against gravity forces

14. The apparatus of claim 13, wherein the part defining portion comprises at least a part of a casting mold system.

15. The apparatus of claim 14, wherein the part of the casting mold is defined by a core.

16. The apparatus of claim 13, wherein the firing support portion isolates the part defining portion from a furnace floor.

17. The apparatus of claim 1, wherein the green article has anisotropic shrinkage characteristics associated with the transformation to a sintered article.

18. A method comprising:
forming a layered green ceramic article having a firing support portion and a part portion by stereolithography;
tuning a thermal response property of the firing support portion and the part portion; and
thermally removing a sacrificial binder from the green ceramic article.

19. The method of claim 18, which further includes moving the firing support portion with the part portion while preventing sag of the part portion during said thermally removing.

20. The method of claim 18, wherein said tuning includes matching the thermal shrinkages of the firing support portion and the integral part portion.

21. The method of claim 18, wherein said tuning allows the firing support portion and the part portion to shrink at the same rate during said thermally removing.

22. The method of claim 18, wherein said forming produces an integral firing support portion and a part portion.

23. The method of claim 18, which further includes sintering the green ceramic article; and
which further includes moving the firing support portion with the part portion while preventing sag of the part portion with the firing support portion during said thermally removing and said sintering.

24. The method of claim 18, which further includes supporting the part portion with the firing support portion to compensate for at least one force during said thermally removing.

25. The method of claim 18, which further includes compensating for the anisotropic shrinkage associated of the green ceramic article.

26. The method of claim 18, which further includes sintering the green ceramic article; and
wherein in said forming the dimensions of the green ceramic article have been adjusted by a shrinkage factor in each of the three dimensions of the article to compensate for anisotropic shrinkage associated with at least said sintering.

27. The method of claim 26, wherein the shrinkage factors include a first shrinkage factor applicable in the X direction of the article and a second shrinkage factor applicable in the Y direction of the article and a third shrinkage factor applicable in the Z direction of the article.

28. The method of claim 26, wherein the shrinkage factor in each of the three dimensions are unequal.

29. An apparatus comprising:
a green body formed of a plurality of layers coupled together by a sacrificial polymer binder, each of the plurality of layers includes a particulate material held together by the sacrificial polymer binder; and
means for reducing deformation of the green body during burnout and sintering.

30. An apparatus comprising:
a green article construction having a part and a firing support in mutual engagement, the part and the support having a similar shrinkage property when thermally processed; and
an interface defined by the engagement between the part and the firing support, the interface is operable to be non-stationary relative to a furnace when the green article construction is thermally processed.

31. The apparatus of claim 30, wherein the green article shrinks anisotropically when sintered to a sintered article.

32. The apparatus of claim 30, wherein the green article is a green ceramic article.

33. The apparatus of claim 30, wherein the green article has a structure consistent with formation by stereolithography; and
wherein the firing support supports the part against gravitational forces.

34. The apparatus of claim 30, wherein the part and the firing support are separate items.
